(19) United States
(12) Patent Application Publication
(10) Pub. No.: US 2016/0277510 A1
(43) Pub. Date: Sep. 22, 2016

(54) RESPONSE PROTOTYPES WITH ROBUST SUBSTITUTION RULES FOR SERVICE VIRTUALIZATION

(71) Applicant: CA, INC., New York, NY (US)

(72) Inventors: Miao Du, Mitcham (AU); Steven Cornelis Versteeg, Ivanhoe (AU)

(21) Appl. No.: 14/661,514

(22) Filed: Mar. 18, 2015

(51) Int. Cl. H04L 29/08; H04L 12/26

(52) U.S. Cl. CPC H04L 67/16; H04L 67/32; H04L 43/50

(57) ABSTRACT

In a method of service emulation, a transaction subset including ones of a plurality of message transactions previously communicated between a system under test and a target system for emulation is defined. The message transactions include requests and responses thereto that are stored in a computer-readable memory. Variable sections of the requests and variable sections of the responses of the transaction subset are identified, for example, based on respective message structures thereof. Substitution rules, which indicate a correspondence between respective ones of the variable sections of the requests and respective ones of the variable sections of the responses, are determined for the transaction subset based on commonalities therebetween. Responsive to receiving an incoming request from the system under test, a response to the incoming request is generated according to the substitution rules. Related computer systems and computer program products are also discussed.

### BACKGROUND

Various embodiments described herein relate to computer systems, methods and program products and, more particularly, to virtualized computer systems, methods and computer program products.

Modern enterprise software environments may integrate a large number of software systems to facilitate complex business processes. Many of these software systems may interact with and/or rely on services provided by other systems (e.g., third-party systems or services) in order to perform their functionalities or otherwise fulfill their responsibilities, and thus, can be referred to as “systems of systems.”

Assuring the quality of such software systems (including the functionality which interacts with third-party systems or services) before deployment into actual production environments (i.e., “live” deployment) may present challenges, for example, where the systems interoperate across heterogeneous services provided by large scale environments. For example, physical replication and provisioning of real-world deployment environments can become difficult to effectively manage or even achieve, as recreating the heterogeneity and massive scale of typical production environments (often with thousands of real client and server hardware platforms, suitably configured networks, and appropriately configured software applications for the system under test to communicate with) may be difficult given the resources of a quality assurance (QA) team. Accessing these environments may also may also involve difficulty and/or expense, and the different environment configurations may affect the operational behavior of such software systems. For example, access to real third party services during testing may be restricted, expensive, and/or unavailable at a scale that is representative of the production environment. Thus, due to the complex interaction between a software system and its operating environment, traditional standalone-system-oriented testing techniques may be inadequate for quality assurance.

Enterprise software environment emulation may be used as an alternative approach to providing interactive representations of operating environments. Software service emulation (or “service virtualization”) may refer to emulation of the behavior of specific components in heterogeneous component-based environments or applications, such as API-driven applications, cloud-based applications and/or service-oriented architectures. Service virtualization allows the communication between a client and software service to be virtualized, such that the virtual service can respond to requests from the client system with generated responses. With the behavior of the components or endpoints simulated by a model or “virtual asset” (which stands in for a component by listening for requests and returning an appropriate response), testing and development can proceed without accessing the actual live components of the system under test. For instance, instead of virtualizing an entire database (and performing all associated test data management as well as setting up the database for every test session), the interaction of an application with the database may be monitored, and the related database behavior may be emulated (e.g., SQL queries that are passed to the database may be monitored, and the associated result sets may be returned, and so forth). For a web service, this might involve listening for extensible markup language (XML) messages over hypertext transfer protocol (HTTP), Java® message service (JMS), or IBM® Web Sphere MQ, then returning another XML message. Thus, the virtual asset's functionality and performance may reflect the functionality/performance of the actual component, and/or may simulate conditions (such as extreme loads or error conditions) to determine how an application or system under test responds under those circumstances.

By modeling the interaction behavior of individual systems in an environment and subsequently simultaneously executing a number of those models, an enterprise software environment emulator can provide an interactive representation of an environment which, from the perspective of an external software system, appears to be a real or actual operating environment. Manually defining interaction models may offer advantages in defining complex sequences of request/response patterns between elements of the system including suitable parameter values. However, in some cases, such an approach may not be feasible due to the time required or lack of required expertise. In particular, manually defining interaction models (including complex sequences of request/response patterns and suitable parameter values) may require knowledge of the underlying interaction protocol(s) and system behavior(s). Such information may often be unavailable at the required level of detail (if at all), for instance, when third-party, legacy, and/or mainframe systems are involved. Additionally, the large number of components and component interactions in such systems may make manual approaches time-consuming and/or error-prone. Also, due to lack of control over the environment, if an environment changes with new enterprise elements or communication between elements, these manual protocol specifications must be further updated.

### BRIEF SUMMARY

According to some embodiments, in a method of service emulation, a transaction subset including ones of a plurality of message transactions previously communicated between a system under test and a target system for emulation is defined. The message transactions include requests and responses thereto that are stored in a computer-readable memory. Variable sections of the requests and variable sections of the responses of the transaction subset are identified, for example, based on respective message structures thereof. Substitution rules, which indicate a correspondence between respective ones of the variable sections of the requests and respective ones of the variable sections of the responses, are determined for the transaction subset based on commonalities therebetween. Responsive to receiving an incoming request from the system under test, a response to the incoming request is generated according to the substitution rules. The defining of the transaction subset, the identifying of the variable sections of the requests and responses, the determining of the substitution rules, and the generating of the response are performed by a processor.

In some embodiments, the commonalities between the variable sections of the requests and the variable sections of the responses may include common substrings. For respective pairs including one of the requests and a corresponding one of the responses thereto, the common substrings included in the respective ones of the variable sections thereof may be identified, and symmetric field rules correlating the respective ones of the variable sections thereof having the common substrings may be defined. The symmetric field rules for the respective request-response pairs may be merged to define the substitution rules for the transaction subset.

In some embodiments, the symmetric field rules for the respective request-response pairs may be merged based on a frequency of occurrence of the symmetric field rules.

In some embodiments, the symmetric field rules for the respective request-response pairs may be merged by clustering ones of the symmetric field rules into respective groups based on similarities therebetween calculated using a distance function, and selecting a representative one of the symmetric field rules from the respective groups as one of the substitution rules. For example, a centroid or modal one of the symmetric field rules may be selected as one of the substitution rules.

In some embodiments, the variable sections of the requests and the variable sections of the responses of the transaction subset may be identified by decoding the requests and the responses using a message parser based on predetermined information indicative of respective message structures thereof.

In some embodiments, the variable sections of the requests and the variable sections of the responses of the transaction subset may be identified independent of predetermined information indicative of respective message structures thereof by generating, for the transaction subset, a request prototype including common characters that are present at respective positions of ones of the requests thereof, and a response prototype including common characters that are present at respective positions of ones of the responses thereof. The variable sections of the requests of the transaction subset may be determined based on an absence of the common characters at corresponding positions of the request prototype, and the variable sections of the responses of the transaction subset may be determined based on an absence of the common characters at corresponding positions of the response prototype.

In some embodiments, in generating the request prototype and the response prototype, the requests of the transaction subset may be aligned according to the respective positions thereof, and the common characters for the request prototype may be selected based on a frequency of occurrence thereof at the respective positions of the requests of the transaction subset as indicated by the aligning of the requests. Similarly, the responses of the transaction subset may be aligned according to the respective positions thereof, and the common characters for the response prototype may be selected based on a frequency of occurrence thereof at the respective positions of the responses of the transaction subset as indicated by the aligning of the responses.

In some embodiments, in generating the response to the incoming request, variable sections of the incoming request may be identified based on a comparison of the incoming request with the corresponding positions of the request prototype. Ones of the corresponding positions of the response prototype may be populated with data from ones of the variable sections of the incoming request as specified by the substitution rules to generate the response thereto.

In some embodiments, in generating the response to the incoming request, the transaction subset may be identified, among a plurality of transaction subsets, as corresponding to the incoming request based on a comparison of the incoming request with the request prototype of the transaction subset. The plurality of transaction subsets may respectively include different ones of the message transactions, where the ones of the message transactions included in the transaction subset are of a same operation type.

In some embodiments, the transaction subset may be defined by clustering the ones of the message transactions based on similarities therebetween calculated using a distance function.

In some embodiments, the transaction subset may be defined responsive to user selection of the ones of the message transactions.

According to further embodiments, a computer system includes a processor, and a memory coupled to the processor. The memory includes computer readable program code embodied therein that, when executed by the processor, causes the processor to define a transaction subset that includes ones of a plurality of message transactions previously communicated between a system under test and a target system for emulation. The message transactions include requests and responses thereto stored in a computer-readable memory. The memory further includes computer readable program code embodied therein that, when executed by the processor, causes the processor to identify variable sections of the requests and variable sections of the responses of the transaction subset, and determine substitution rules for the transaction subset. The substitution rules indicate a correspondence between respective ones of the variable sections of the requests and respective ones of the variable sections of the responses based on commonalities therebetween. Responsive to receiving an incoming request from the system under test, the computer readable program code, when executed by the processor, further causes the processor to generate a response to the incoming request according to the substitution rules.

According to still further embodiments, a computer program product includes a computer readable storage medium having computer readable program code embodied in the medium. The computer readable program code includes computer readable code to define a transaction subset that includes ones of a plurality of message transactions previously communicated between a system under test and a target system for emulation. The message transactions include requests and responses thereto that are stored in a computer-readable memory. The computer readable program code further includes computer readable code to identify variable sections of the requests and variable sections of the responses of the transaction subset, and computer readable code to determine substitution rules for the transaction subset. The substitution rules indicate a correspondence between respective ones of the variable sections of the requests and respective ones of the variable sections of the responses based on commonalities therebetween. The computer readable program code further includes computer readable code to generate a response to an incoming request from the system under test according to the substitution rules.

It is noted that aspects described herein with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present disclosure, and be protected by the accompanying claims.

### BRIEF DESCRIPTION OF THE DRAWINGS

Aspects of the present disclosure are illustrated by way of example and are not limited by the accompanying figures with like references indicating like elements.

FIG. 1 is a block diagram of a computing system or environment for service emulation in accordance with some embodiments of the present disclosure.

FIG. 2 is a block diagram that illustrates computing device for service emulation in accordance with some embodiments of the present disclosure.

FIG. 3 is a block diagram that illustrates a software/hardware architecture for service emulation in accordance with some embodiments of the present disclosure.

FIGS. 4-5 are flowcharts illustrating methods for service emulation in accordance with some embodiments of the present disclosure.

FIG. 6 is a block diagram illustrating an example computing system or environment for service emulation.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

As described herein, a computing system or environment may include one or more hosts, operating systems, peripherals, and/or applications. Machines in a same computing system or environment may have shared memory or resources, may be associated with the same or different hardware platforms, and/or may be located in the same or different physical locations. Computing systems/environments described herein may refer to a virtualized environment (such as a cloud environment) and/or a physical environment.

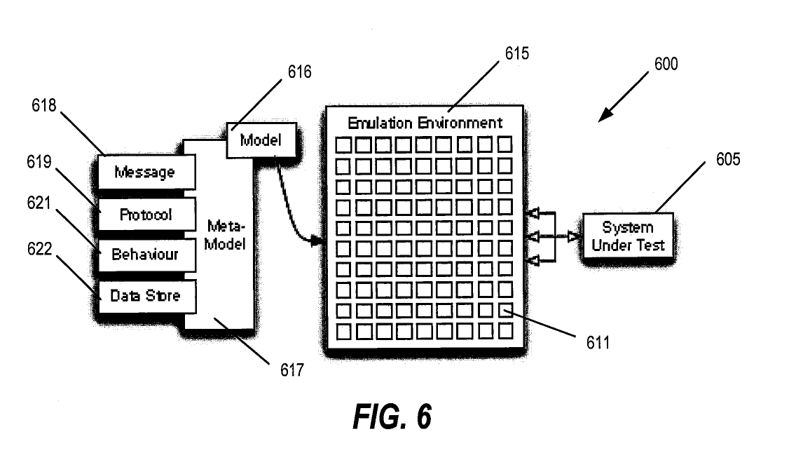

In assuring quality of a system under test (for example, a large enterprise system), physical replication of real-world deployment environments may be difficult or impossible to achieve. Thus, an emulation environment where realistic interactive models of the third party services are executed may be useful for purposes of quality assurance and/or development and operations (DevOps). In particular, such “virtual” deployment environments may be used to provision representations of diverse components, as shown by way of example in the environment 600 of FIG. 6. The environment 600 may allow a system under test 605 to interact with a large-scale heterogeneous emulation environment 615, which can be provided by a software environment emulator. The emulation environment 615 is capable of simultaneously emulating multiple (e.g., on the order of hundreds or thousands) endpoint systems 611 on one or more physical machines, and may employ scalable models 616 to allow for scalability and performance testing. The models 616 may be created from meta models 617, which may be constructed from messages 618, protocols 619, behavior 621, and/or data store(s) 622.

However, in some instances, scaling of the environment 615 to handle the number of likely endpoints 611 in the deployment scenario may require pre-existing knowledge of (i) a likely maximum number of endpoints; (ii) the likely maximum number of messages between endpoint and system; (iii) the likely frequency of message sends/receives needed for the system to respond in acceptable timeframe; (iv) the likely size of message payloads given deployment network latency and bandwidth; and/or (v) the system's robustness in the presence of invalid messages, too-slow response from end-points, or no-response from endpoints. Also, messages being exchanged between the system under test 605 and the endpoints 611 should adhere to various protocols; for example, a Lightweight Directory Access Protocol (LDAP) message sent by the system under test 605 to an endpoint 611 should be responded to with a suitable response message in reply, in an acceptable timeframe and with acceptable message payload. Subsequent messages sent by the system under test 605 to the endpoint using the LDAP response message payload may also need to utilize the previous response information. As such, the creation of such executable endpoint models 611 may require the availability of a precise specification and/or prior detailed knowledge of the interaction protocols 619 used, may be relatively time consuming and/or error-prone, and may be subject to considerable implementation and/or maintenance effort in heterogeneous deployment environments.

Software service emulation or virtualization can create realistic executable models of server-side behavior, thereby replicating production-like conditions for large-scale enterprise software systems, for instance, by generating responses to requests from a system under test using symmetric field substitution. Symmetric field substitution (or “magic strings”) may refer to methods in service virtualization for generating and modifying a played back response to a system under test by substituting substrings from a new incoming request from the system under test into the generated response. The substrings may be common character sequences, of a length greater than a given threshold, which occur in both the request and the associated response of a selected message transaction.

Some embodiments of the present disclosure may arise from realization that some methods for symmetric field substitution may be based on a comparison of a single request and response, and thus, may be prone to errors in response generation due to coincidental similarity between requests and responses. Accordingly, embodiments of the present disclosure provide systems and methods for defining more robust substitution rules that correlate sections of requests to sections of responses, in particular, by calculating symmetric fields from commonalities among groupings or subsets of similar requests and responses thereto. For example, some embodiments as described in detail herein may improve accuracy and/or efficiency in response generation by generating respective prototypes or templates that capture the common features of the range of requests, as well as the common features of the range of responses, in each subset. Embodiments of the present disclosure can be applied to opaque service virtualization (i.e., agnostic of or without pre-existing knowledge of protocols or message structures) or for standard service virtualization (i.e., with pre-existing knowledge of message structures or protocols).

In particular, embodiments of the present disclosure are directed to a service emulation or virtualization approach that simulates enterprise system element interaction behavior by grouping message transactions (including requests and responses thereto) that were previously communicated between a system under test and endpoint or elements/components in its deployment environment into transaction subsets of the same operation type, and determining (for each transaction subset) substitution rules that indicate a correlation between variable sections of the previously recorded request(s) and variable sections of the previously recorded response(s) corresponding thereto. Responsive to receiving an incoming request from a system under test, embodiments of the present disclosure (i) identify variable section(s) of the incoming request based on commonalities and differences between the incoming request and one(s) of the requests from the group (or a request prototype representative of the group), and (iii) generate a response using data from the variable section(s) of the incoming request and substitution rules that indicate a correlation between variable sections of the previously recorded request(s) and variable sections of the previously recorded response(s) corresponding thereto.

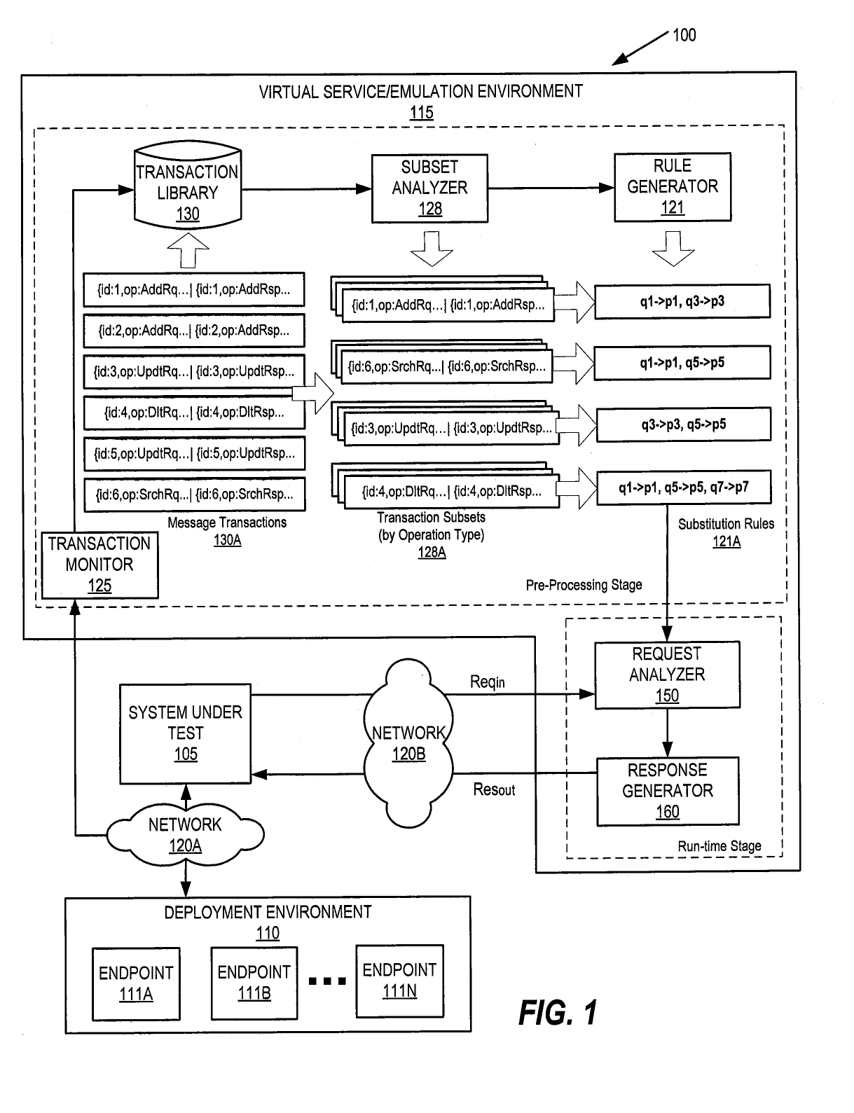

An approach for generating responses using more robust request prototypes is described below with reference to the block diagram of FIG. 1, which illustrates operation of a computing system or environment 100 for service emulation in accordance with embodiments of the present disclosure. Referring now to FIG. 1, the environment 100 includes a system under test 105, a deployment environment 110 including a plurality of endpoints 111A, 111B, . . . 111N, and a virtual service environment (also referred to herein as an emulation environment) 115. The deployment environment 110 may include one or more software services upon which the system under test 105 depends or otherwise interacts to fulfill its responsibilities. The emulation environment 115 includes a transaction monitor 125, a transaction subset analyzer 128, a substitution rule generator 121, a request analyzer 150, a response generator 160, and a message transaction library 130. The message transaction library 130 stores message transactions (including requests and associated responses; generally referred to herein as messages) sampled and recorded from prior communications with (i.e., to and/or from) a client (here, the system under test 105) and a target service for emulation or virtualization (here, the deployment environment 110) by the transaction monitor 125.

As shown in FIG. 1, embodiments of the present invention provide a message analysis function (as performed by subset analyzer 128) for the message transactions stored in the transaction library 130, and a substitution rule generation function (as performed by rule generator 121) for the transaction subsets defined by the subset analyser 128, to provide a response prototypes and substitution rules to a matching function (as performed by request analyzer 150) and a translation function (as performed by response generator 160), which operate to improve the accuracy of response generation by the emulation environment 115. A framework according to some embodiments is split into 2 consecutive stages, that is, the offline or pre-processing stage and the run-time stage shown in FIG. 1.

In the pre-processing stage, the transaction monitor 125 is configured to record message transactions (including requests and responses thereto) communicated with (i.e., to and/or from) the system under test 105 or other client. In particular, as shown in FIG. 1, message transactions 130A (in the form of request-response pairs) communicated between the system under test 105 and the endpoint(s) 111A, 111B, . . . 111N, are recorded by a transaction monitor 125, for example, using a network sniffer tool. The transaction monitor 125 stores these observed message transactions in the transaction library 130.

Also in the pre-processing stage, the subset analyzer 128 is configured to partition the message transactions 130A of the transaction library 130 into transaction subsets or “clusters” 128A. The message transactions may be included in a particular transaction subset responsive to user direction, or automatically using a data clustering method. As shown in FIG. 1, the message transactions 130A are clustered into different transaction subsets 128A based on a similarity thereof. The similarity may be determined by a distance function (such as the Needleman-Wunsch sequence alignment algorithm). The distance function may be applied to cluster the message transactions based on request similarity, response similarity, or a combination of the request and response similarities. In the example embodiment of FIG. 1, the transaction subsets 128A may be generated such that request-response pairs having a same operation type are grouped in a same cluster. For example, the distance function may assign different weights to different parts of the messages based on a relative variability of a particular position or section relative to other messages in the transaction library thereof as an indicator of respective operation types contained therein, as discussed in detail U.S. patent application Ser. No. 14/211,933 entitled “ENTROPY WEIGHTED MESSAGE MATCHING FOR OPAQUE SERVICE VIRTUALIZATION,” the disclosure of which is incorporated by reference herein.

Still referring to the pre-processing stage, the subset analyzer 128 is configured to identify variable sections of the requests and variable sections of the responses of one or more of the transaction subsets 128A, for example, based on respective message structures thereof. When the message structures of the requests and responses are already known (for example, in standard service virtualization), the subset analyser 128 may employ a message parser to decode the requests and responses into fields that indicate the variable sections thereof. When the message structures of the requests and responses are unknown (for example, in opaque service virtualization), the subset analyser 128 may be configured to generate request and response prototypes that include the common features of the requests and responses, and are indicative of the variable sections of the requests and responses, respectively, of the corresponding transaction subset 128A. The request and response prototypes may be generated using methods described in U.S. patent application Ser. No. 14/535,950 entitled “SYSTEMS AND METHODS FOR AUTOMATICALLY GENERATING MESSAGE PROTOTYPES FOR ACCURATE AND EFFICIENT OPAQUE SERVICE EMULATION,” filed Nov. 7, 2014, the disclosure of which is incorporated by reference herein in its entirety.

In particular, the request and response prototypes for a transaction subset 128A may include one or more commonalities among the request messages and the response messages, respectively, of that transaction subset 128A. In some embodiments, for one or more of the transaction subsets 128A, the subset analyzer 128 may align the request messages to identify common features or characters at respective positions thereof, and may likewise align the response messages to identify common features or characters at respective positions thereof. Gap characters may be inserted among the request messages and/or response messages of each subset 128A to align the positions of the messages. The subset analyzer 128 may select the common character(s) for inclusion in the request and response prototypes based on a frequency of occurrence at respective positions of the aligned requests and responses. The subset analyser 128 may also determine the variable sections of the requests and responses for a transaction subset 128A from the absence of common characters at corresponding positions of the request and response prototypes for that subset 128A. The request and response prototypes generated for each transaction subset 128A may also be used at the run-time stage to increase the efficiency and accuracy of response generation.

In the pre-processing stage of FIG. 1, the rule generator 121 is configured to generate substitution rules 121A for one or more of the transaction subsets 128A. The substitution rules 121A indicate a correlation or correspondence between variable section(s) of the requests and variable section(s) of the responses of a particular transaction subset 128A based on commonalities between the variable sections of the requests and responses. For example, for one or more request-response pairs of a transaction subset 128A, the rule generator 121 may identify substrings that are common to variable section(s) of the request and the corresponding response (for each request-response pair), and may define symmetric field rules that correlate the variable section(s) of the request to the variable section(s) of the response for each request-response pair of a transaction subset 128A. The rule generator 121 may then merge the symmetric field rules for a number of the request-response pairs of a particular transaction subset 128A to define the substitution rules for that transaction subset 128A. The merging may be performed based on a frequency of occurrence of the symmetric field rules, based on similarities among the symmetric field rules (for instance, as determined using a distance function), and/or other method of selecting representative one(s) of the symmetric field rules for a particular transaction subset 128A as substitution rules.

At the runtime stage, the emulation environment 115 receives a request message Reqᵢₙ from the system under test 105 at the request analyzer 150 via a network 120B. The request message Reqᵢₙ may be transmitted from the system under test 105 to request a particular service provided by one or more of the endpoints 111A, 111B, . . . 111N of the deployment environment 110. The request analyzer 150 is configured to indirectly identify at least one of the transaction subsets 128A that corresponds to the operation type requested by the request message Reqᵢₙ, for instance, by comparing the incoming request message Reqᵢₙ with the request prototypes for each of the transaction subsets 128A, in some embodiments without knowledge or determination of the structure or protocol of the received request message Reqᵢₙ. For example, the request analyzer 150 may use a matching distance calculation technique to compare the current request Reqᵢₙ received from the system under test 105 to the respective request prototypes for each of the transaction subsets 128A to identify one of the transaction subsets 128A as corresponding to the received request Reqᵢₙ. Results of the analysis by the request analyzer 150 (for example, indicating the closest-matching transaction subset 128A, request prototype, and/or associated response prototype) are provided to the response generator 160. As used herein, a “matching” or “corresponding” prototype, cluster, message, request, and/or response, as determined for example by the request analyzer 150, may refer to similar (but not necessarily identical) prototypes/messages/requests/responses.

Still referring to the runtime stage, the response generator 160 is configured to synthesize or otherwise generate a response message Resₒᵤₜ to the incoming request Reqᵢₙ according to the substitution rules 121A for the particular transaction subset 128A that was indicated by the request analyzer 150. For example, the response generator 160 may identify one or more variable sections of the incoming request Reqᵢₙ based on a comparison of the incoming request Reqᵢₙ with the corresponding position(s) of the request prototype for the transaction subset 128A indicated by the request analyzer 150, and may populate the corresponding position(s) of the associated response prototype (for that same transaction subset 128A) with data from ones of the variable sections of the incoming request based on the substitution rules 121A for the transaction subset 128A that was indicated by the request analyzer 150. Thus, the response Resₒᵤₜ is automatically generated using the received request Reqᵢₙ from the system under test 105 using one of the request-response pairs of a selected transaction subset 128A and the corresponding substitution rules 121A, and is returned to the system under test 105 via the network 120B.

In some embodiments of the present disclosure, a distance function may be used for calculations in multiple operations described herein. For example, respective distance functions may be used in subset definition, prototype generation, and symmetric field rule merging operations in the pre-processing stage, as well as in request analysis at the runtime stage. Example distance functions may include the Cartesian distance of the (i, j, L) vector, the Cosine distance, the Manhattan distance, the Needleman-Wunsch algorithm, and/or other distance functions.

It will be appreciated that in accordance with various embodiments of the present disclosure, the emulation environment 115 may be implemented as a single server, separate servers, or a network of servers (physical and/or virtual), which may be co-located in a server farm or located in different geographic regions. In particular, as shown in the example of FIG. 1, the emulation environment 115 is coupled to the system under test 105 via network 120B. The deployment environment 110 may likewise include a single server, separate servers, or a network of servers (physical and/or virtual), coupled via network 120A to the system under test 105. The networks 120A, 120B may be a global network, such as the Internet or other publicly accessible network. Various elements of the networks 120A, 120B may be interconnected by a wide area network (WAN), a local area network (LAN), an Intranet, and/or other private network, which may not be accessible by the general public. Thus, the communication networks 120A, 120B may represent a combination of public and private networks or a virtual private network (VPN). The networks 120A, 120B may be a wireless network, a wireline network, or may be a combination of both wireless and wireline networks. Although illustrated as separate networks, it will be understood that the networks 120A, 120B may represent a same or common network in some embodiments. As such, one or more of the system under test 105, the deployment environment 110, and the emulation environment 115 may be co-located or remotely located, and communicatively coupled by one or more of the networks 120A and/or 120B. More generally, although FIG. 1 illustrates an example of a computing environment 100, it will be understood that embodiments of the present disclosure are not limited to such a configuration, but are intended to encompass any configuration capable of carrying out the operations described herein.

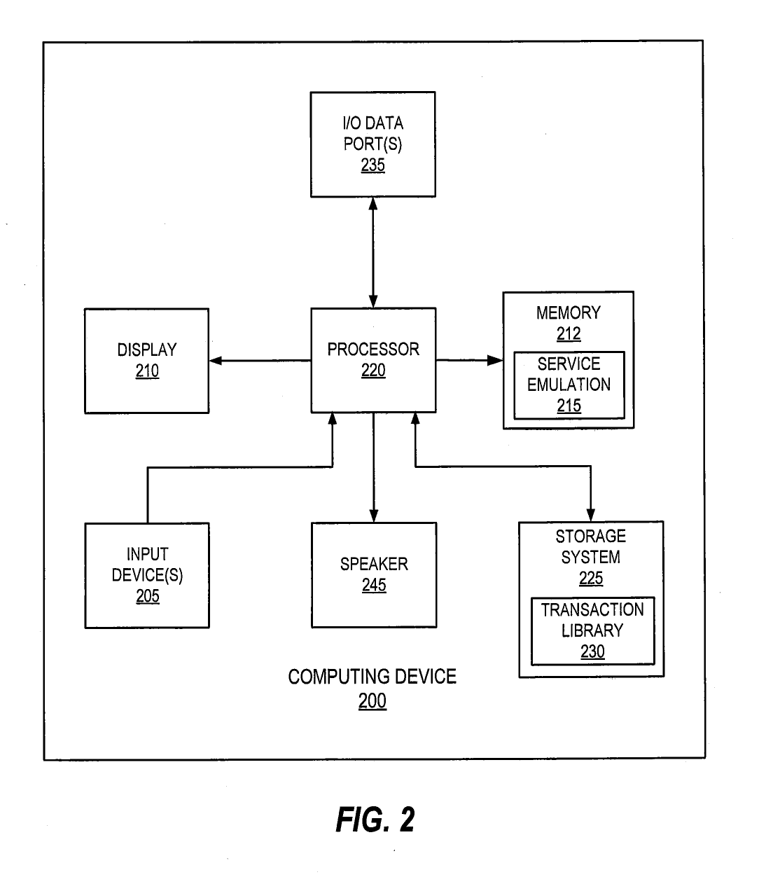

FIG. 2 illustrates an example computing device 200 in accordance with some embodiments of the present disclosure. The device 200 may be used, for example, to implement the virtual service environment 115 in the system 100 of FIG. 1 using hardware, software implemented with hardware, firmware, tangible computer-readable storage media having instructions stored thereon, or a combination thereof, and may be implemented in one or more computer systems or other processing systems. The computing device 200 may also be a virtualized instance of a computer. As such, the devices and methods described herein may be embodied in any combination of hardware and software.

As shown in FIG. 2, the computing device 200 may include input device(s) 205, such as a keyboard or keypad, a display 210, and a memory 212 that communicate with one or more processors 220 (generally referred to herein as “a processor”). The computing device 200 may further include a storage system 225, a speaker 245, and I/O data port(s) 235 that also communicate with the processor 220. The memory 212 may include a service emulation function 215 installed thereon. The service emulation function 215 may be configured to mimic the behavior of a target system for emulation in response to a request or other message received from a system under test, as described in detail with reference to the virtual service environment 115 of FIG. 1.

The storage system 225 may include removable and/or fixed non-volatile memory devices (such as but not limited to a hard disk drive, flash memory, and/or like devices that may store computer program instructions and data on computer-readable media), volatile memory devices (such as but not limited to random access memory), as well as virtual storage (such as but not limited to a RAM disk). The storage system 225 may include a transaction library 230 storing data (including but not limited to requests and associated responses) communicated between a system under test and a target system for emulation. Although illustrated in separate blocks, the memory 212 and the storage system 225 may be implemented by a same storage medium in some embodiments. The input/output (I/O) data port(s) 235 may include a communication interface and may be used to transfer information in the form of signals between the computing device 200 and another computer system or a network (e.g., the Internet). The communication interface may include a modem, a network interface (such as an Ethernet card), a communications port, a PCMCIA slot and card, or the like. These components may be conventional components, such as those used in many conventional computing devices, and their functionality, with respect to conventional operations, is generally known to those skilled in the art. Communication infrastructure between the components of FIG. 2 may include one or more device interconnection buses such as Ethernet, Peripheral Component Interconnect (PCI), and the like.

As mentioned above, in an enterprise system emulation environment (such as the environment 100 of FIG. 1), a request Reqᵢₙ (sent from the enterprise system under test) should be responded to by the emulated operating environment (such as the emulation environment 115) according to the various interaction protocols between the components of the deployment environment (such as the deployment environment 110). Such interaction protocols include LDAP, HTTP/HTTPS, SOAP, SMTP, SMB, etc. In an emulation environment, a request message Reqᵢₙ sent from an enterprise system under test is responded to with a generated response message Resₒᵤₜ, rather than an actual response message from the deployment environment. This allows a complex, large-scale emulation environment to be provided to the system under test without the scalability and configuration limitations of other techniques. However, emulation techniques can be critically dependent on the ability of the emulation environment to generate accurate responses to the requests.

The observable interaction request messages and response messages communicated between a system under test and a target system contain two types of information: (i) protocol structure information (such as the operation name, field names and field delimiters), used to describe the type and format of a message and (ii) payload information, which includes attribute values of a records or objects and metadata. In general, given a collection of message interactions conforming to a specific interaction protocol, the repeated occurrence of protocol structure information may be common, as only a limited number of operations are defined in the protocol specification. In contrast, payload information is typically quite diverse according to the various objects and records exposed by the service. Message transaction analysis may thus be used to group similar observed messages into subsets, infer constant sections of messages (which may include protocol-related information) from variable sections of messages (which may include record or object related information) by comparing messages within a same subset, and determine substitution rules for response message generation by identifying common substrings among the variable sections of request-response message pairs, even without prior knowledge of the particular protocol used in the message transactions.

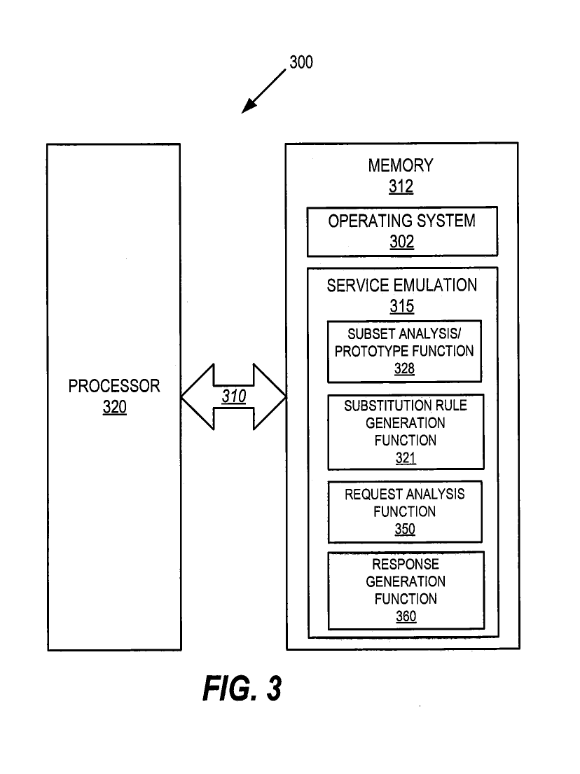

FIG. 3 illustrates a computing system or environment for opaque service emulation in accordance with further embodiments of the present disclosure. In particular, FIG. 3 illustrates a processor 320 and memory 312 that may be used in computing devices or other data processing systems, such as the computing device 200 of FIG. 2 and/or the virtual service environment 115 of FIG. 1. The processor 320 communicates with the memory 312 via an address/data bus 310. The processor 320 may be, for example, a commercially available or custom microprocessor, including, but not limited to, digital signal processor (DSP), field programmable gate array (FPGA), application specific integrated circuit (ASIC), and multi-core processors. The memory 312 may be a local storage medium representative of the one or more memory devices containing software and data in accordance with some embodiments of the present invention. The memory 312 may include, but is not limited to, the following types of devices: cache, ROM, PROM, EPROM, EEPROM, flash, SRAM, and DRAM.

As shown in FIG. 3, the memory 312 may contain multiple categories of software and/or data installed therein, including (but not limited to) an operating system block 302 and a service emulation block 315. The operating system 302 generally controls the operation of the computing device or data processing system. In particular, the operating system 302 may manage software and/or hardware resources and may coordinate execution of programs by the processor 320, for example, in providing the service emulation environment 115 of FIG. 1.

The service emulation block 315 is configured to carry out some or all of the functionality of the subset analyzer 128, the rule generator 121, the request analyzer 150, and/or the response generator 160 of FIG. 1. In particular, the service emulation block 315 includes a subset analysis/prototype function 328, a substitution rule generation function 321, a request analysis function 350, and a response generation function 360, which are configured to implement the functionality of the subset analyzer 128, the rule generator 121, the request analyzer 150, and the response generator 160 of FIG. 1, respectively.

For example, responsive to accessing a transaction library including a set of messages (including requests and associated responses) communicated between a client (such as the system under test 105 of FIG. 1) and a target service for virtualization (such as one or more of the endpoints 111A . . . 111N of the deployment environment 110 of FIG. 1), the subset analysis/prototype function 328 groups similar ones of the messages transactions to partition the transaction library into subsets or “clusters” of similar request-response pairs, for example, having the same operation type. The similarity is determined using one or more distance measures or functions (such as the Needleman-Wunsch sequence alignment algorithm).

The subset analysis/prototype function 328 further identifies variable sections of the requests and variable sections of the responses of one or more of the transaction subsets, for example, based on respective message structures thereof. For example, if the message structures of the requests and responses are known, the subset analysis/prototype function 328 may be configured to apply a message parser to decode the requests and responses into fields that indicate the variable sections. If the message structures are unknown, the subset analysis/prototype function 328 may be configured to infer the constant and variable sections of the requests and responses, for example, by generating request and response prototypes for each of the transaction subsets.

The request and response prototypes function as representatives for the requests and responses, respectively, of the corresponding transaction subset. For example, responsive to a multiple sequence alignment of the requests and a multiple sequence alignment of the responses of a subset, a consensus request prototype and a consensus response prototype may be calculated by selecting, at each byte (or character) position, the most commonly occurring byte or character at that position, provided the byte/character has a relative frequency above a predetermined threshold. In other words, the request or response prototype may include a particular byte/character at a particular position when there is a consensus (among the requests or responses of the cluster) as to the commonality of the byte at that position). Positions for which there is no consensus may be populated with one or more wildcard characters in the request or response prototype.

The subset analysis/prototype function 328 may thus identify the variable sections of the requests and responses for a transaction subset based on the presence of wildcard characters at corresponding positions of the request and response prototypes generated for that subset. For instance, for each request-response pair of a transaction subset, the subset analysis/prototype function 328 may compare may compare the request to the request prototype and the response to the response prototype to determine the variable sections based on alignment of such sections with the wildcard characters of the prototypes.

It will be understood that these and/or other operations of the subset analysis/prototype function 328 may be performed as a pre-processing step, prior to any response generation. Also, the pre-processing transaction subset generation operations performed by the subset analysis/prototype function 328 may utilize the same distance function utilized by the request analysis function 350 in run-time response generation operations (as discussed below), or a different distance function may be used.

Still referring to FIG. 3, to improve accuracy in response generation, the substitution rule generation function 321 generates substitution rules for one or more of the transaction subsets defined by the subset analysis/prototype function 328. The substitution rules indicate a correspondence between variable section(s) of the requests and variable section(s) of the responses of a particular transaction subset based on commonalities between the variable sections of the requests and responses. For example, for each request-response pair of a transaction subset, the substitution rule generation function 321 may identify substrings that are common to variable section(s) of the request and the corresponding response (for each request-response pair), and may define symmetric field rules that correlate the variable section(s) of the request to the variable section(s) of the response. For each transaction subset, the substitution rule generation function 321 can merge the symmetric field rules defined for its constituent request-response pairs to define the substitution rules for that transaction subset, for example, based on a frequency of occurrence of the symmetric field rules among the request-response pairs, or based on similarities among the symmetric field rules as calculated using a distance function.

At run-time, the request analysis function 350 compares an unknown, incoming request with the request prototype for each of the transaction subsets generated by the subset analysis/prototype function 328, in order to select a particular one of the subsets that includes requests most similar to the incoming message. For example, the subset corresponding to the request prototype having the minimum distance to the incoming request may be selected as the matching subset, which will typically include message transactions having the same operation type as the incoming request. Thus, rather than comparing the incoming request to all of the requests in the transaction library, the request analysis function 350 compares the incoming request only with the request prototypes, reducing the processing burden and allowing for increased speed and efficiency.

The response generation function 360 performs response generation using the response prototype from the transaction subset selected by the request analyzer function 350, by applying the corresponding substitution rules determined by the substitution rule generation function 321. In particular, the response generation function 360 identifies variable sections of the incoming request from comparison with corresponding positions of the request prototype, and populates the corresponding variable sections of the paired response prototype (as indicated by the substitution rules) with values from the variable sections of the incoming request. The response generation function 360 may thereby generate the response independent of receiving data or other knowledge indicating structural information (including the protocol, operation type, and/or header information) of the incoming request, by substituting fields from the variable sections of the request into corresponding sections of the response prototype according to substitution rules that relate sections of the requests to sections of the responses for each operation type.

Although FIG. 3 illustrates example hardware/software architectures that may be used in a device, such as the computing device 200 of FIG. 2, to provide opaque service emulation in accordance with some embodiments described herein, it will be understood that the present invention is not limited to such a configuration but is intended to encompass any configuration capable of carrying out operations described herein. Moreover, the functionality of the computing device 200 of FIG. 2 and the hardware/software architecture of FIG. 3 may be implemented as a single processor system, a multi-processor system, a processing system with one or more cores, a distributed processing system, or even a network of stand-alone computer systems, in accordance with various embodiments.

Computer program code for carrying out the operations described above and/or illustrated in FIGS. 1-3 may be written in a high-level programming language, such as COBOL, Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

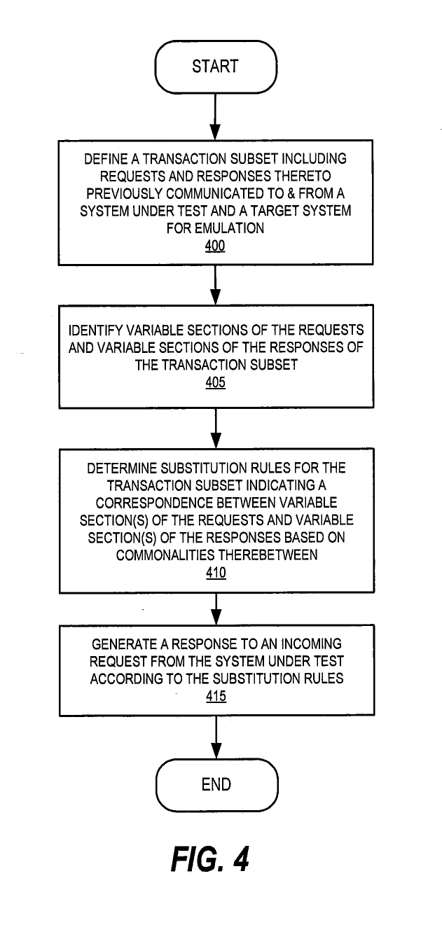

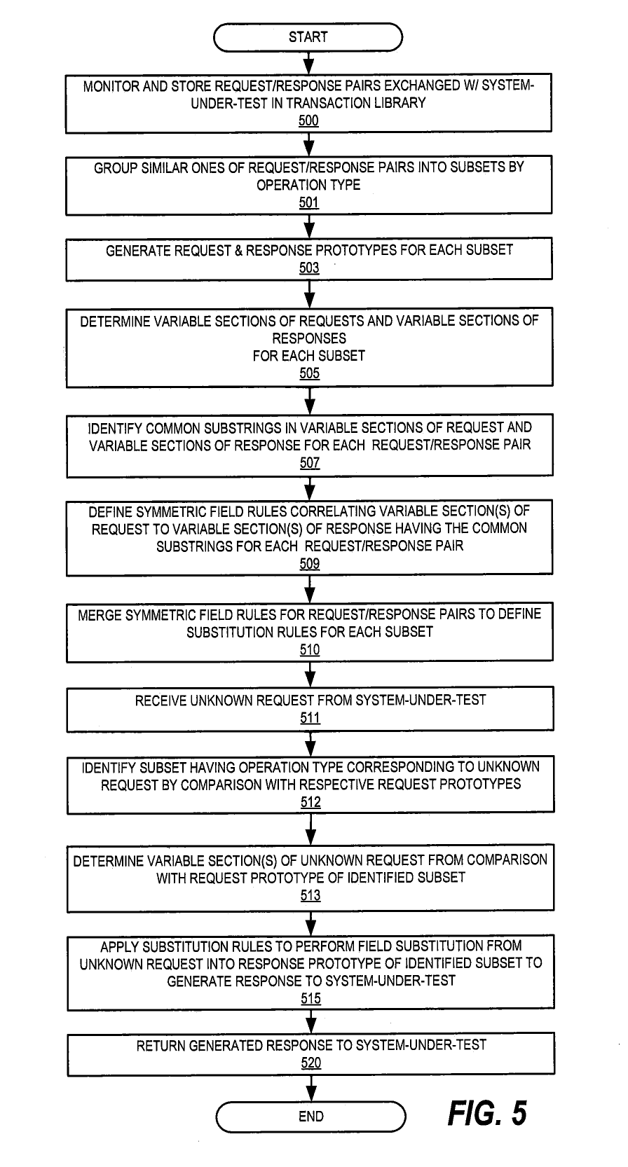

Operations for providing service emulation in accordance with some embodiments of the present disclosure will now be described with reference to the flowcharts of FIGS. 4 and 5. FIGS. 4 and 5 illustrate operations that may be performed by a virtual service environment (such as the environment 115 of FIG. 1) to emulate the behavior of a target system for virtualization (such as the environment 110 of FIG. 1) in response to a request from the system under test (such as the system under test 105 of FIG. 1).

Referring now to FIG. 4, operations begin at block 400 where a transaction subset is defined from message transactions (including requests and associated responses) that have been previously communicated with (i.e., to and/or from) a system under test. For example, the message transactions may be stored in a transaction library (such as the library 130 of FIG. 1), and may be clustered based on relative similarities to define transaction subsets including similar ones of the stored messages. The relative similarities of the stored messages may be determined in response to user input, or may be calculated using a distance function or measure, such as the Needleman-Wunsch sequence alignment algorithm. For example, the distance function may be applied based on request similarity, response similarity, or a combination of request and response similarities. In some embodiments, the distance function may weight different parts of the messages differently. For example, different weightings may be assigned to respective sections of the messages based on a relative variability thereof as an indicator of respective information types contained therein.

At block 405, variable sections of the requests and variable sections of the responses of a particular transaction subset are identified, for example, based on respective message structures thereof. The message structures of the requests and responses may be based on pre-programmed information (e.g., in standard service virtualization), or may be determined from message prototypes (e.g., in opaque service virtualization). In particular, a request prototype (including common characters that are present at respective positions of the requests of the transaction subset) and a response prototype (including common characters that are present at respective positions of the responses of the transaction subset) may be generated (for example, based on sequence alignment), and the variable sections of the requests and responses may be determined from the absence of common characters at corresponding positions thereof.

Substitution rules for the transaction subset are determined at block 410. The substitution rules indicate a correspondence between variable section(s) of the requests and variable section(s) of the responses based on commonalities therebetween. For example, for one or more request-response pairs of the transaction subset, substrings that are common to variable section(s) of the request and response in each pair may be identified, and symmetric field rules may be defined to correlate the variable section(s) of the request to the variable section(s) of the response in each request-response pair. The symmetric field rules for a number of request-response pairs may be merged (for instance, based on frequency of occurrence of the symmetric field rules or based on representative one(s) of the symmetric field rules) to define the substitution rules for the transaction subset.

At block 415, a response to an incoming request from the system under test is generated according to the substitution rules. For instance, variable sections of the incoming requests may be identified based on a comparison of the incoming request with the request prototype for the transaction subset, and positions of the response prototype corresponding to the identified ones of the variable sections of the incoming request may be populated as specified by the substitution rules to generate the response.

FIG. 5 illustrates operations for providing service emulation in accordance with some embodiments of the present disclosure in greater detail, where blocks 500-510 illustrate pre-processing operations, while blocks 511-520 are directed to runtime operations. Referring now to FIG. 5, operations begin at block 500 by monitoring communication messages (including request-response pairs; also referred to as “message transactions”) exchanged between a system under test and one or more endpoints, and storing the request-response pairs in a transaction library. The endpoint(s) may correspond to a system upon which the system under test depends (that is, where the system under test is a client), such as the endpoints 111A-111N of the deployment environment 110 of FIG. 1. The request-response pairs stored in the transaction library are used to determine substitution rules that correlate sections thereof, such that a response to an incoming request from the system under test can be generated by applying the substitution rules to a response prototype or template corresponding to the incoming request.

In particular, at block 501, the request-response pairs stored in the transaction library are pre-processed to group similar ones of the request-response pairs into respective transaction subsets. A transaction subset may include a group of requests/responses, typically of the same operation type. The requests/responses to be included in each transaction subset can be selected manually (that is, responsive to a user indication) or automatically, for example, using message clustering. Examples of such message clustering are described in U.S. patent application Ser. No. 14/305,322 entitled “SYSTEMS AND METHODS FOR CLUSTERING TRACE MESSAGES FOR EFFICIENT OPAQUE RESPONSE GENERATION,” filed Jun. 16, 2014, the disclosure of which is incorporated by reference herein in its entirety. For instance, relative distances between respective requests and/or respective responses may be calculated based on a clustering distance measure, and the transaction library may be partitioned based on the relative distances such that the transaction subsets respectively include message transactions having similar relative distances. A data clustering method or algorithm (such as VAT), BEA, K-Means, a hierarchical clustering algorithm, etc.) may be used to group message transactions into subsets of similar messages. For instance, a distance matrix may be generated to include the relative distances for the respective requests and responses, and the clustering algorithm may be applied to the distance matrix to group request-response pairs having similar relative distances into a particular transaction subset. As such, each transaction subset may include message transactions of a same operation type, based on the computed similarities therebetween.

Table 1 below illustrates an example transaction subset, which will be used hereinafter to illustrate processing operations in accordance with some embodiments of the present disclosure. Note that the transaction subset of Table 1 includes request-response pairs for an “Add” operation.

TABLE 1
Example transaction subset

| # | Request | Response |
|---|---|---|
| 1 | {Id:1,Op:AddRq,Lastname:Du, | {Id:1,Op:AddRsp,Result:Ok, |
| | Firstname:Miao} | Lastname:Du,Key:0} |
| 2 | {Id:2,Op:AddRq,Lastname: | {Id:2,Op:AddRsp,Result:Ok, |
| | Versteeg,Firstname:Steve} | Lastname:Versteeg,Key:2} |
| 3 | {Id:13,Op:AddRq,Lastname: | {Id:13,Op:AddRsp,Result:Ok, |
| | Karamazov,Firstname:Fyodor} | Lastname:Karamazov,Key:3} |
| 4 | {Id:24,Op:AddRq,Lastname: | {Id:24,Op:AddRsp,Result:Ok, |
| | Smerdyakov,Firstname:Pavel} | Lastname:Smerdyakov,Key:4} |
| 5 | {Id:25,Op:AddRq,Lastname: | {Id:25,Op:AddRsp,Result:Ok, |
| | Svetlova,Firstname:Grushka} | Lastname:Svetlova,Key:5} |

At Block 503, a request prototype and a response prototype are generated for each transaction subset. The operations of block 503 are performed to identify variable message sections/fields of the requests and responses of a transaction subset for an opaque (i.e. unknown structure) communications protocol. However, if the message structure/communications protocol is known (for example, in standard service virtualization or otherwise based on pre-programmed information), the operations of block 503 may be omitted, and operations may continue at block 505.

To generate the request and response prototypes at block 503, a multiple sequence alignment of the requests and responses for the transaction subset may be performed. In particular, for the example transaction subset of Table 1, the requests align as:

{Id:1-,Op:AddRq,Lastname:---------Du,Firstname:---Miao}

{Id:2-,Op:AddRq,Lastname:V-er--steeg,Firstname:--Steve}

{Id:25,Op:AddRq,Lastname:S-ve--tlova,Firstname:Grushka}

{Id:13,Op:AddRq,Lastname:-Karamazov-,Firstname:Fyodor-}

{Id:24,Op:AddRq,Lastname:Smerdyakov-,Firstname:Pavel--},

and the responses align as:

{Id:1-,Op:AddRsp,Result:Ok,-Lastname:---------Du,Key:0}

{Id:2-,Op:AddRsp,Result:Ok, Lastname:V-er--steeg,Key:2}

{Id:25,Op:AddRsp,Result:Ok,-Lastname:S-ve--tlova,Key:5}

{Id:13,Op:AddRsp,Result:Ok,-Lastname:-Karamazov-,Key:3}

{Id:24,Op:AddRsp,Result:Ok,-Lastname:Smerdyakov-,Key:4}

Still referring to block 503, a respective consensus prototype may be generated for the aligned requests, as well as for the aligned responses. The request and response prototypes may be generated using methods described in U.S. patent application Ser. No. 14/535,950 entitled “SYSTEMS AND METHODS FOR AUTOMATICALLY GENERATING MESSAGE PROTOTYPES FOR ACCURATE AND EFFICIENT OPAQUE SERVICE EMULATION,” filed Nov. 7, 2014, the disclosure of which is incorporated by reference herein in its entirety. For the example transaction subset of Table 1, a threshold of 0.8 was used to calculate the following request and response consensus prototypes. That is, common characters occurring at respective positions of ones of the requests and responses with a frequency at or above the 0.8 threshold (as indicated by the above alignments) were included in corresponding positions of the request and response prototypes, respectively. A wildcard character “?” was included in positions of the request and response prototypes for corresponding positions of the requests and responses that did not meet the 0.8 threshold. In particular, the consensus prototype for the requests of the example transaction subset of Table 1 is:

{Id: ??, Op: AddRq, Lastname:????????, Firstname:???????}

The consensus prototype for the responses of the example transaction subset of Table 1 is:

{Id:??,Op:AddRsp,Result:Ok,Lastname:????????,Key:?}

At block 505, variable sections of the requests and variable sections of the responses of the transaction subset are determined. For example, if the message structure/communications protocol is known (e.g., in standard service virtualization, or otherwise based on pre-programmed information), a message parser can be applied to decode the raw messages into fields, where the decoded fields are equivalent to the variable message sections. If the message structure is unknown (e.g., in opaque service virtualization), the request and response prototypes generated at block 503 may be used to deduce the constant and variable sections of the requests and responses, respectively. For instance, one or more common characters at positions of the request and response prototypes may indicate a constant section, while one or more wildcards (included due to an absence of common characters among the requests or responses) at positions of the request and response prototypes may indicate a variable section. The request and response prototypes for each transaction subset may thus be divided into constant and variable sections, and labeled or numbered accordingly.

For the example transaction subset of Table 1, the variable and constant sections for the request prototype are shown below in Table 2a:

TABLE 2a
Variable and constant sections for example request prototype

| q0 | q1 | q2 | q3 | q4 | q5 | q6 |
|---|---|---|---|---|---|---|
| const | var | const | var | const | var | const |
| {Id: | ?? | ,Op:AddRq,Lastname: | ???????? | ,Firstname: | ??????? | } |

The variable and constant sections for the response prototype are shown below in Table 2b:

TABLE 2b
Variable and constant sections for example response prototype

| p0 | p1 | p2 | p3 | p4 | p5 | p6 |
|---|---|---|---|---|---|---|
| const | var | const | var | const | var | const |
| {Id: | ?? | ,Op:AddRsp,Result:Ok,Lastname: | ???????? | ,Key: | ? | } |

At block 507, for one or more request-response pairs in the transaction subset, common substrings that occur in both a variable section of a request and in a variable section of its corresponding response are identified. For example, for the transaction subset, each request-response pair may be aligned with the request prototype and the response prototype, respectively, and substrings in the variable request sections which also occur in the variable response sections may be identified. Gaps inserted during the alignment may be ignored during this matching process. Table 3a illustrates alignment of the request prototype and first request of the example transaction subset of Table 1:

TABLE 3a
Alignment of example request prototype with example first request

| q0 | q1 | q2 | q3 | q4 | q5 | q6 |
|---|---|---|---|---|---|---|
| const | var | const | var | const | var | const |
| {Id: | ?? | ,Op:AddRq,Lastname: | ???????? | ,Firstname: | ??????? | } |
| {Id: | −1 | ,Op:AddRq,Lastname: | ------Du | ,Firstname: | ---Miao | } |

Table 3b illustrates alignment of the response prototype and first response of the example transaction subset of Table 1:

TABLE 3b
Alignment of example response prototype with example first response

| p0 | p1 | p2 | p3 | p4 | p5 | p6 |
|---|---|---|---|---|---|---|
| const | var | const | var | const | var | const |
| {Id: | ?? | ,Op:AddRsp,Result:Ok,Lastname: | ???????? | ,Key: | ? | } |
| {Id: | −1 | ,Op:AddRsp,Result:Ok,Lastname: | ------Du | ,Key: | 0 | } |

As shown above in Tables 3a and 3b, for the first request-response pair of Table 1, section q1 of the first request and section p1 of the first response both contain the common character “1”. Also section q3 of the first request and section p3 of the first response contain the common substring “Du”.

At block 509, for one or more of the request-response pairs of the transaction subset, symmetric field rules are defined. The symmetric field rules correlate variable section(s) of the request to variable section(s) of the response for a given request-response pair. For instance, for each symmetric field that occurs in both a variable section of a request and a variable section of a response for a given pair, a symmetric field rule may be defined in the form:

qₐ->p_{b} (1)

Where qₐ, is a section of the request, and p_{b} is a matching section of the response for the request-response pair. Note qₐ may map to multiple sections of the response, so it may be possible to have multiple rules with the same value of q₄, but different values for p_{b}. If the variable sections in the request and response match completely (i.e., an entire section of the request, matches an entire section of the response, ignoring any gaps), the symmetric field rule may be defined in the form above. If there is a partial match (i.e., a whole or subsection of the request matches a whole or subsection of the response), the symmetric field rule may be defined in the form:

qₐ[i . . . (i+L)]->p_{b}[j . . . (j+L)] (2)

Where L is the length of the substring, i and (i+L) are indices in the request section denoting the start and end (exclusive), respectively, of the matching substring, and j and (j+L) are the start and ending (exclusive) indices of the matching substring in a response section.

For example, as shown in Tables 3a and 3b above, for the first request-response pair of Table 1, section q1 of the request is equal to section p1 of the response, while section q3 of the request is equal to section p3 of the response. Applying the symmetric field search to all of the requests/responses in the example transaction subset of Table 1 yields the following symmetric rules for each transaction, illustrated in Table 4:

TABLE 4
Example symmetric field rules for 5 request-response pairs

| # | Symmetric Field Rules |
|---|---|
| 1 | q1 −> p1, q3 −> p3 |
| 2 | q1 −> p1, q3 −> p3, q1 −> p5 |
| 3 | q1 −> p1, q3 −> p3 |
| 4 | q1 −> p1, q3 −> p3 |
| 5 | q1 −> p1, q3 −> p3 |

Note that the example symmetric field rules of Table 4 does not include partial symmetric field matches, which may also occur if that method was being used. For example, in the request-response pair of transaction 3, note that there is a partial match between section q1 and p5, which may be defined using the notation of equation (2) as: q1[5,6]->p5.

At block 510, the symmetric field rules defined in block 509 for the request-response pairs of a transaction subset are merged to define substitution rules for each transaction subset. For example, in some embodiments, the symmetric field rules may be merged based on a relative frequency of occurrence of the rules in the transaction subset. Symmetric field rules which occur with a relative frequency at or above a defined threshold (e.g., 0.8) may be included, while symmetric field rules below the threshold may be discarded. As shown above in Table 4, for the example transaction subset of Table 1, three different symmetric field rules (q1->p1, q3->p3, q1->p5) occur. Table 5 below shows illustrates the relative frequency of each of the three symmetric field rules q1->p1, q3->p3, q1->p5. Using a threshold of 0.8, the first two symmetric field rules (q1->p1, q3->p3) can be included in the substitution rules for the transaction subset, while the last symmetric field rule (q1->p5) can be discarded.

TABLE 5
Frequency of occurrence of example symmetric field rules

| Rule | Frequency | Relative Frequency | Include? |
|---|---|---|---|
| q1 −> p1 | 5 | 1 | Y |
| q3 −> p3 | 5 | 1 | Y |
| q1 −> p5 | 1 | 0.2 | N |

Still referring to block 510, in other embodiments, the symmetric field rules may be merged by clustering ones of the symmetric field rules into respective groups based on calculated similarities, and selecting a representative one of the symmetric field rules from each group (such as the centroid or modal element) as the merged representation to define a substitution rule. Any of a plurality of clustering algorithms (e.g. K-means, VAT, hierarchical clustering, density based clustering, etc.) may be used. Clustering may be particularly helpful for partial matching rules, where the i, j and L values may be more prone to imprecision as compared to the whole section rules. For the clustering, a distance function may be used to calculate the similarities of the symmetric field rules of a transaction subset. Example distance functions may include the Cartesian distance of the (i, j, L) vector, the Cosine distance, the Manhattan distance, or other distance functions.

At runtime, an unknown request Reqᵢₙ is received from a system under test at block 511. The unknown request Reqᵢₙ may be directed to an endpoint and/or environment for which service emulation is desired, such as the deployment environment 110 of FIG. 1. For example, the unknown request Reqᵢₙ may be in the form of an LDAP or a SOAP message.

At block 512, responsive to receiving the unknown request Reqᵢₙ, one of the transaction subsets including message transactions of an operation type corresponding to the unknown request is selected. The transaction subset may be identified by comparing the unknown request to the respective request prototypes (or other representative requests) of each of the transaction subsets. For example, in opaque service virtualization, a similarity of the received request to each of the request prototypes may be determined using a distance function, and one of the transaction subsets corresponding to the closest-matching one of the request prototypes may be identified, as similarly described in the above-referenced U.S. patent application Ser. No. 14/535,950 incorporated by reference herein. The distance function used in transaction subset identification at block 512 may be the same as or different than the distance function(s) used in transaction subset generation at block 501, prototype generation at block 503, and/or symmetric field rule merging at block 510, and may be independent of a message structure (which may indicate protocol, operation type, and/or header information) of the unknown request, such that a closest matching one of the request prototypes may be indirectly identified based on similarity, rather than based on the contents thereof. In some embodiments, a maximum distance threshold may be used such that, if no transaction subsets are identified as having a distance to the unknown request Reqᵢₙ less than the maximum distance threshold, then a default response (such as an error message) may be generated and transmitted to the system under test.

At block 513, variable section(s) of the unknown request are determined from a comparison with the request prototype of the transaction subset that was identified at block 512. For example, with reference to the request prototype of the example transaction subset of Table 1, upon receiving a request:

{Id:133,Op:AddRq,Lastname:Verkhovtseva,Firstname:Katya},

the received request is aligned with the request prototype, and the variable section(s) of the incoming/unknown request may be identified from the alignment, as shown below in Table 6:

TABLE 6
Alignment of example unknown request with example request prototype

| q0 | q1 | q2 | q3 | q4 | q5 | q6 |
|---|---|---|---|---|---|---|
| const | var | const | var | const | var | const |
| {Id: | -?? | ,Op:AddRq,Lastname: | ----???????? | ,Firstname: | ??????? | } |
| {Id: | 133 | ,Op:AddRq,Lastname: | Verkhovtseva | ,Firstname: | --Katya | } |

At block 515, the substitution rules for the transaction subset, which were defined at block 510, are applied to the response prototype of the transaction subset that was identified at block 512 to generate a response to the system under test. In particular, symmetric field substitution may be performed to fill in values for the appropriate variable sections of the response prototype, from the corresponding variable sections of the incoming request as determined at block 513, based on the substitution rules. For example, for the response prototype of the example transaction subset of Table 1:

### {Id:??,Op:AddRsp,Result:Ok,Lastname:????????,Key:?}

The two substitution rules (q1->p1, q3->p3) defined for the example transaction subset of Table 1 are applied to populate the variable sections p1 and p3 in the response prototype with the values of variable sections q1 (133) and q3 (Verkhovtseva) to generate a response:

TABLE 7
Example response prototype populated according to substitution rules

| p0 | p1 | p2 | p3 | p4 | p5 | p6 |
|---|---|---|---|---|---|---|
| const | var | const | var | const | var | const |
| {Id: | 133 | ,Op:AddRsp,Result:Ok,Lastname: | Verkhovtseva | ,Key: | ? | } |

The remaining unpopulated sections of the response prototype (if any) are then populated. For example, a closest matching request in the transaction subset to the incoming request may be determined (using a distance function), and sections from the corresponding/paired response may be copied to the generated response. In the example transaction subset of Table 1, if the closest matching request in the transaction subset was the request-response pair of transaction 4, the missing section p5 would be populated with the value “4”. Alternatively, a response may be selected at random from the transaction subset, and sections from the selected response to the missing sections of the generated response. For example, request-response pair of transaction 3 may be selected at random from the example transaction subset of Table 1, and the section p5 would be populated with “3”. Similarly, a response may be selected at random for each missing section of the generated response, and the appropriate section may be copied from the randomly selected response. As such, a generated response including multiple missing sections may have sections copied from multiple responses of the transaction subset. As another alternative, for each missing section of the generated response, a string may be randomly generated to populate the section. The length of the string may be restricted to be within the range of lengths observed for the section in the transaction subset. The alphabet used may also be restricted, for example, to only use characters observed to occur in the transaction subset for the section.

Still referring to block 515, using the first of the missing field approaches discussed above, the final generated response would be:

{Id:133,Op:AddRsp,Result:Ok,Lastname:Verkhovtseva,Key:4}

At block 520, the generated response is transmitted to the system under test, in response to the unknown request received therefrom.

Aspects of the present disclosure have been described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. As used herein, “a processor” may refer to one or more processors.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Although some of the diagrams include arrows on communication paths to show a primary direction of communication, it is to be understood that communication may occur in the opposite direction to the depicted arrows. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” (and variants thereof) when used herein, specify the presence of stated features, integers, steps, operations, elements, and/or components, but do not preclude the presence or addition of one or more other features, integers, steps, operations, elements, components, and/or groups thereof. In contrast, the term “consisting of” (and variants thereof) when used in this specification, specifies the stated features, integers, steps, operations, elements, and/or components, and precludes additional features, integers, steps, operations, elements and/or components. Elements described as being “to” perform functions, acts and/or operations may be configured to or otherwise structured to do so. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the various embodiments described herein.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

In the drawings and specification, there have been disclosed typical embodiments and, although specific terms are employed, they are used in a generic and descriptive sense only and not for purposes of limitation, the scope of the disclosure being set forth in the following claims.

1. A method of service emulation, the method comprising:
defining a transaction subset comprising ones of a plurality of message transactions previously communicated between a system under test and a target system for emulation, the message transactions comprising requests and responses thereto that are stored in a computer-readable memory;
identifying variable sections of the requests and variable sections of the responses of the transaction subset;
determining substitution rules for the transaction subset indicating a correspondence between respective ones of the variable sections of the requests and respective ones of the variable sections of the responses based on commonalities therebetween; and
responsive to receiving an incoming request from the system under test, generating a response thereto according to the substitution rules;
wherein the defining, the identifying, the determining, and the generating comprise operations performed by a processor.

2. The method of claim 1, wherein the commonalities comprise common substrings, and wherein determining the substitution rules comprises:
identifying, for respective pairs comprising one of the requests and one of the responses thereto, the common substrings included in the respective ones of the variable sections thereof;
defining, for the respective pairs comprising one of the requests and one of the responses thereto, symmetric field rules correlating the respective ones of the variable sections thereof having the common substrings; and
merging the symmetric field rules for the respective pairs to define the substitution rules for the transaction subset.

3. The method of claim 2, wherein the merging is based on a frequency of occurrence of the symmetric field rules for the respective pairs.

4. The method of claim 2, wherein the merging comprises:
clustering ones of the symmetric field rules into respective groups based on similarities therebetween calculated using a distance function; and
selecting one of the symmetric field rules from the respective groups as one of the substitution rules.

5. The method of claim 1, wherein identifying the variable sections of the requests and the variable sections of the responses of the transaction subset comprises:
decoding the requests and the responses using a message parser based on predetermined information indicative of respective message structures thereof.

6. The method of claim 1, wherein identifying the variable sections of the requests and the variable sections of the responses of the transaction subset comprises:
generating, for the transaction subset, a request prototype comprising common characters that are present at respective positions of ones of the requests thereof and a response prototype comprising common characters that are present at respective positions of ones of the responses thereof; and
determining the variable sections of the requests of the transaction subset based on an absence of the common characters at corresponding positions of the request prototype; and
determining the variable sections of the responses of the transaction subset based on an absence of the common characters at corresponding positions of the response prototype.

7. The method of claim 6, wherein generating the request prototype and the response prototype comprises:
aligning the requests of the transaction subset according to the respective positions thereof;
selecting the common characters for the request prototype based on a frequency of occurrence thereof at the respective positions of the requests of the transaction subset as indicated by the aligning of the requests;
aligning the responses of the transaction subset according to the respective positions thereof; and
selecting the common characters for the response prototype based on a frequency of occurrence thereof at the respective positions of the responses of the transaction subset as indicated by the aligning of the responses.

8. The method of claim 6, wherein generating the response to the incoming request comprises:
identifying variable sections of the incoming request based on a comparison of the incoming request with the corresponding positions of the request prototype; and
populating ones of the corresponding positions of the response prototype with data from ones of the variable sections of the incoming request as specified by the substitution rules to generate the response thereto.

9. The method of claim 8, wherein generating the response to the incoming request further comprises:
identifying the transaction subset, among a plurality of transaction subsets respectively comprising different ones of the message transactions, as corresponding to the incoming request based on a comparison of the incoming request with the request prototype of the transaction subset, wherein the ones of the message transactions included in the transaction subset are of a same operation type.

10. A computer system, comprising:
a processor; and
a memory coupled to the processor, the memory comprising computer readable program code embodied therein that, when executed by the processor, causes the processor to:
define a transaction subset comprising ones of a plurality of message transactions previously communicated between a system under test and a target system for emulation, the message transactions comprising requests and responses thereto that are stored in a computer-readable memory;
identify variable sections of the requests and variable sections of the responses of the transaction subset;
determine substitution rules for the transaction subset indicating a correspondence between respective ones of the variable sections of the requests and respective ones of the variable sections of the responses based on commonalities therebetween; and
responsive to receiving an incoming request from the system under test, generate a response thereto according to the substitution rules.

11. The computer system of claim 10, wherein the commonalities comprise common substrings, and wherein, to determine the substitution rules, the computer readable program code, when executed by the processor, further causes the processor to:
identify, for respective pairs comprising one of the requests and one of the responses thereto, the common substrings included in the respective ones of the variable sections thereof;
define, for the respective pairs comprising one of the requests and one of the responses thereto, symmetric field rules correlating the respective ones of the variable sections thereof having the common substrings; and
merge the symmetric field rules for the respective pairs to define the substitution rules for the transaction subset.

12. The computer system of claim 10, wherein, to merge the symmetric field rules, the computer readable program code, when executed by the processor, further causes the processor to:
cluster ones of the symmetric field rules into respective groups based on similarities therebetween calculated using a distance function; and
select one of the symmetric field rules from the respective groups as one of the substitution rules.

13. The computer system of claim 10, wherein, to identify the variable sections of the requests and the variable sections of the responses of the transaction subset, the computer readable program code, when executed by the processor, further causes the processor to:
generate, for the transaction subset, a request prototype comprising common characters that are present at respective positions of ones of the requests thereof and a response prototype comprising common characters that are present at respective positions of ones of the responses thereof; and
determine the variable sections of the requests of the transaction subset based on an absence of the common characters at corresponding positions of the request prototype; and
determine the variable sections of the responses of the transaction subset based on an absence of the common characters at corresponding positions of the response prototype.

14. The computer system of claim 13, wherein, to generate the request prototype and the response prototype, the computer readable program code, when executed by the processor, further causes the processor to:
align the requests of the transaction subset according to the respective positions thereof; select the common characters for the request prototype based on a frequency of occurrence thereof at the respective positions of the requests of the transaction subset as indicated by alignment of the requests;
align the responses of the transaction subset according to the respective positions thereof; and
select the common characters for the response prototype based on a frequency of occurrence thereof at the respective positions of the responses of the transaction subset as indicated by alignment of the responses.

15. The computer system of claim 13, wherein, to generate the response to the incoming request, the computer readable program code, when executed by the processor, further causes the processor to:
identify variable sections of the incoming request based on a comparison of the incoming request with the corresponding positions of the request prototype; and
populate ones of the corresponding positions of the response prototype with data from ones of the variable sections of the incoming request as specified by the substitution rules to generate the response.

16. A computer program product, comprising:
a computer readable storage medium having computer readable program code embodied in the medium, the computer readable program code comprising:
computer readable code to define a transaction subset comprising ones of a plurality of message transactions previously communicated between a system under test and a target system for emulation, the message transactions comprising requests and responses thereto that are stored in a computer-readable memory;
computer readable code to identify variable sections of the requests and variable sections of the responses of the transaction subset;
computer readable code to determine substitution rules for the transaction subset indicating a correspondence between respective ones of the variable sections of the requests and respective ones of the variable sections of the responses based on commonalities therebetween; and
computer readable code to generate a response to an incoming request from the system under test according to the substitution rules.

17. The computer program product of claim 16, wherein the commonalities comprise common substrings, and wherein the computer readable program code to determine the substitution rules comprises:
computer readable program code to identify, for respective pairs comprising one of the requests and one of the responses thereto, the common substrings included in the respective ones of the variable sections thereof;
computer readable program code to define, for the respective pairs comprising one of the requests and one of the responses thereto, symmetric field rules correlating the respective ones of the variable sections thereof having the common substrings; and
computer readable program code to merge the symmetric field rules for the respective pairs to define the substitution rules for the transaction subset.

18. The computer program product of claim 16, wherein, the computer readable program code to identify the variable sections of the requests and the variable sections of the responses of the transaction subset comprises:
computer readable program code to generate, for the transaction subset, a request prototype comprising common characters that are present at respective positions of ones of the requests thereof and a response prototype comprising common characters that are present at respective positions of ones of the responses thereof; and
computer readable program code to determine the variable sections of the requests of the transaction subset based on an absence of the common characters at corresponding positions of the request prototype; and
computer readable program code to determine the variable sections of the responses of the transaction subset based on an absence of the common characters at corresponding positions of the response prototype.

19. The computer program product of claim 18, wherein the computer readable program code to generate the request prototype and the response prototype comprises:
computer readable program code to align the requests of the transaction subset according to the respective positions thereof;
computer readable program code to select the common characters for the request prototype based on a frequency of occurrence thereof at the respective positions of the requests of the transaction subset as indicated by alignment of the requests;
computer readable program code to align the responses of the transaction subset according to the respective positions thereof; and
computer readable program code to select the common characters for the response prototype based on a frequency of occurrence thereof at the respective positions of the responses of the transaction subset as indicated by alignment of the responses.

20. The computer program product of claim 18, wherein the computer readable program code to generate the response to the incoming request comprises:
computer readable program code to identify variable sections of the incoming request based on a comparison of the incoming request with the corresponding positions of the request prototype; and
computer readable program code to populate ones of the corresponding positions of the response prototype with data from ones of the variable sections of the incoming request as specified by the substitution rules to generate the response.
